(19) United States
(12) Patent Application Publication
(10) Pub. No.: US 2020/0334317 A1
(43) Pub. Date: Oct. 22, 2020

(54) METHODS AND SYSTEMS FOR CACHING AND SEARCHING FOR SEARCH RESULTS

(71) Applicant: Citrix Systems, Inc., Fort Lauderdale, FL (US)

(72) Inventor: Henry John Ashman, Cambridge (GB)

(21) Appl. No.: 16/385,465

(22) Filed: Apr. 16, 2019

(51) Int. Cl. G06F 16/957; G06F 16/953; G06F 16/901

(52) U.S. Cl. CPC G06F 16/9574; G06F 16/901; G06F 16/953

(57) ABSTRACT

A method comprises searching results stored on caches and obtaining a first subset of results from the caches in response to a search query initiated from a client device. The results stored in the one or more caches are cached from search results received from respective one or more search providers in response to one or more other search queries. The first subset of results is obtained by searching in at least one of the one or more caches using one or more search terms which form the search query initiated from the client device. The method also includes receiving a second subset of results from one or more search providers and returning the first and second subsets of results to the search interface on the client device.

### BACKGROUND

A search engine is an information retrieval system designed to help find information stored on a computer system or on one or more elements of a network where each node may correspond to one or more computer systems. The search engine provides search results in response to a request provided thereto. The search results are often presented in a list and each item in the list is commonly referred to as a “hit.” Search engines typically include a user interface which enables users to enter a search query. The search engine uses the search query to find one or more hits. The one or more hits can be sorted or ranked and then presented to the user.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In one aspect, a method comprises searching, by a search controller, search results stored in one or more caches in response to a search query initiated from a client device. The search results in the one or more caches are cached from search results received from respective one or more search providers in response to one or more other search queries. Additionally, in response to the search query, the method includes obtaining, by the search controller, a first subset of search results from the one or more caches.

In an embodiment, obtaining the first subset of search results from the one or more caches includes searching for results in at least one of the one or more caches using one or more search terms which form the search query initiated from the client device. Thus, the method includes searching the caches irrespective to a relationship between the search query and one or more previously issued search queries. The method also includes receiving, by the search controller, a second subset of search results from one or more search providers. Additionally, the method includes returning, by the search controller, a set of search results second subset to the client device that includes at least one search result from the first subset of search results to reduce a response time to retrieve the search results. The second subset of search results can include search results that update one or more results of the first subset of search results and/or add new results to the first subset of search results.

The method can also include updating, by the search controller, the first subset of search results with the second subset of search results.

In embodiments, the method can also include registering the one or more search providers by the search controller. Registering the one or more search providers can include identifying the one or more search providers and determining one or more types of sources from which each of the identified search providers can return search results in response to search queries.

In additional embodiments, the method can also include establishing, by the search controller, one or more cached search providers, wherein each of the one or more cached search providers corresponds to a respective one of the one or more search providers. The method can further include coupling, by the search controller, each of the one or more cached search providers to the respective one of the one or more caches. Establishing the one or more cached search providers can include determining a response time at which the one or more search providers can return search results and establishing the respective one or more cached search providers if the response time exceeds a threshold.

In embodiments, the method can include in response to receiving the search query determining, by the search controller, the one or more types of sources to fulfill and selecting, by the search controller, the one or more search providers from which to obtain search results based on the determined one or more types of sources to fulfill.

In other embodiments, the method can also include selecting, by the search controller, the one or more cached search providers from which to obtain search results based on the determined one or more types of sources to fulfill.

In response to receiving search results from the one or more search providers, the method can also include storing, by the search controller, each of the search results in the one or more caches. Storing each of the search results in the one or more caches can include formatting each of the search results into a searchable structure. The searchable structure can be a key-value pair. The key can include one or more properties used by a search algorithm to select whether an item should be included in a set of search results. The value can include a set of properties that define a single item.

In another aspect, a server comprises one or more caches and a search controller coupled to the one or more caches. The search controller is configured to perform a search of search results stored in the one or more caches in response to a search query initiated from a client device, obtain a first subset of search results from the one or more caches, and receive a second subset of search results from one or more search providers. The search results stored in the one or more caches are cached from search results received from respective one or more search providers in response to one or more other search queries.

In an embodiment, obtaining the first subset of search results from the one or more caches includes searching for results in at least one of the one or more caches using one or more search terms which form the search query initiated from the client device. Thus, the search controller is configured to search the caches irrespective to a relationship between the search query and one or more previously issued search queries. The search controller is further configured to return a set of search results second subset to the client device that includes at least one search result from the first subset of search results to reduce a response time to retrieve the search results. The second subset of search results can include search results that update one or more results of the first subset of search results and/or add new search results to the first subset of search results.

In embodiments, the search controller is further configured to register the one or more search providers by: identifying the one or more search providers; and determining one or more types of sources from which each of the identified search providers can return search results in response to search queries.

In other embodiments, the search controller can be further configured to establish one or more cached search providers and couple each of the one or more cached search providers to the respective one of the one or more caches. Each of the one or more cached search providers can correspond to a respective one of the one or more search providers. The search controller can establish the one or more caches by determining a response time at which the one or more search providers can return search results and establishing the respective one or more cached search providers if the response time exceeds a threshold.

In additional embodiments, in response to receiving the search query, the search controller can be further configured to: determine the one or more types of sources to fulfill; and select the one or more search providers from which to obtain search results based on the determined one or more types of sources to fulfill.

In further embodiments, the search controller can be further configured to select the one or more cached search providers from which to obtain search results based on the determined one or more types of sources to fulfill.

In another embodiment, in response to receiving search results from the one or more search providers, the search controller can be further configured to store each of the search results in the one or more caches. The search structure can be a key-value pair. The key can include one or more properties used by a search algorithm to select whether an item should be included in a set of search results. The value can include a set of properties that define a single item.

In an additional aspect, a non-transitory computer-readable medium comprising computer-executable instructions, which when executed by one or more processors, cause the one or more processors to, perform a search of search results stored in the one or more caches in response to a search query initiated from a client device, wherein the search results stored in the one or more caches are cached from search results received from respective one or more search providers in response to one or more other search queries; obtain a first subset of search results from the one or more caches, wherein the first subset of the search results is obtained by searching for results in at least one of the one or more caches using one or more search terms which form the search query initiated from the client device; receive a second subset of search results from one or more search providers; and return a set of search results second subset to the client device that includes at least one search result from the first subset of search results so as to reduce a response time to retrieve the search results.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized (hypervisor) system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative operating environment that may be used in accordance with one or more illustrative aspects described herein.

FIG. 6 depicts another illustrative operating environment that may be used in accordance with one or more illustrative aspects described herein.

FIG. 7 is a flow diagram of an illustrative method for performing a search in accordance with one or more illustrative aspects described herein.

FIG. 7A is a flow diagram of an illustrative method for updating caches of one or more cached search providers in accordance with one or more illustrative aspects described herein.

FIG. 8 is a flow diagram of an illustrative method for establishing one or more cached search providers in accordance with one or more illustrative aspects described herein.

FIG. 9 is an illustrative process flow for performing a search in accordance with one or more illustrative aspects described herein.

FIG. 10 is a block diagram of an illustrative computing device in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As a general introduction to the concepts described in more detail below, aspects described herein are directed towards caching search results and searching the caches for information, data, and/or resources (e.g., applications, desktops, files, notifications, and settings). In examples, the information, data, and/or resources are associated with one or more computing environments with which a client device has established a computing session. A search controller may establish caches for each of a plurality of search providers. In response to receiving a search query from the client device, the search controller searches the caches and each of the search providers for results. The search controller returns the results to the client device. The search controller may also cache some or all the results received from the search providers in their respective caches.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

Computing Architecture

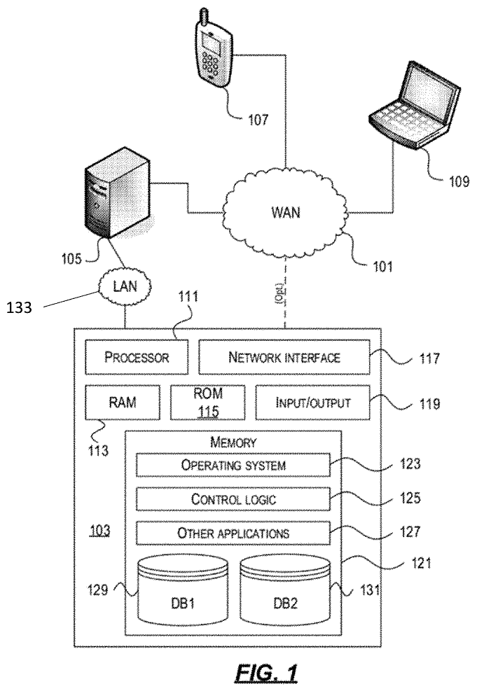

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects described herein in a standalone and/or networked environment. Various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components and devices which make up the system of FIG. 1 may include data server 103, web server 105, and client computers 107, 109. Data server 103 provides overall access, control and administration of databases and control software for performing one or more illustrative aspects described herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

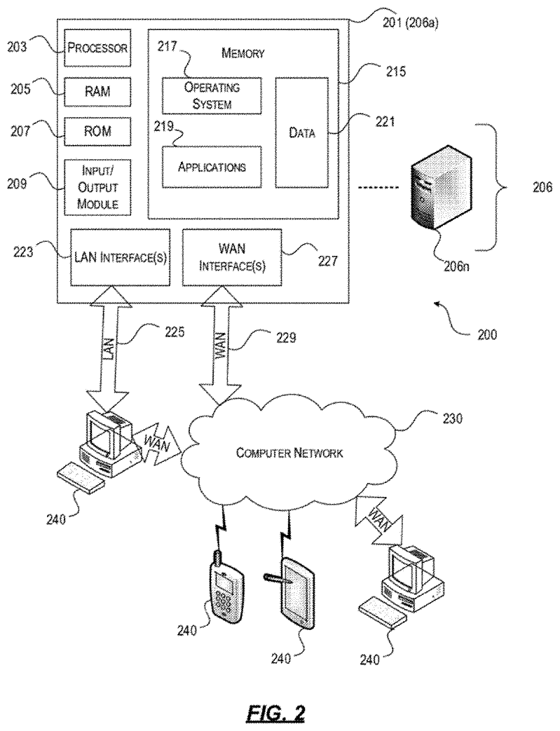

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) configured to provide virtual machines for client access devices. The computing device 201 may have a processor 203 for controlling overall operation of the server and its associated components, including RAM 205, ROM 207, input/output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all the elements described above with respect to the data server 103 or computing device 201. The network connections depicted in FIG. 2 include a local area network (LAN) 225 and a wide area network (WAN) 229 but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, the computing environment 200 may include a network appliance installed between the server(s) 206 and terminals 240. The network appliance may manage client/server connections, and in some cases can load balance client connections amongst a plurality of back-end servers 206.

The terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

A terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). The server 206, in some embodiments, may be referred to as any one of the following non-exhaustive terms: server(s), local machine; remote machine; server farm(s), or host computing device(s).

In one embodiment, the terminal 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a terminal 240.

Some embodiments include a terminal 240 that displays application output generated by an application remotely executing on a server 206 or other remotely located machine. In these embodiments, the terminal 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Fort Lauderdale, Fla.; or the Remote Desktop Protocol (RDP) manufactured by Microsoft Corporation of Redmond, Wash.

A remote computing environment may include more than one server 206a-206n logically grouped together into a server farm 206, for example, in a cloud computing environment. The server farm 206 may include servers 206a-206n that are geographically dispersed while logically grouped together, or servers 206a-206n that are located proximate to each other while logically grouped together. Geographically dispersed servers 206a-206n within a server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, the server farm 206 may be administered as a single entity, while in other embodiments the server farm 206 can include multiple server farms.

In some embodiments, a server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from a terminal 240, forwards the request to a second server 206b (not shown), and responds to the request generated by the terminal 240 with a response from the second server 206b (not shown.) First server 206a may acquire an enumeration of applications available to the terminal 240 and well as address information associated with an application server 206 hosting an application identified within the enumeration of applications. First server 206a can present a response to the client's request using a web interface and communicate directly with the terminal 240 to provide the terminal 240 with access to an identified application. One or more terminals 240 and/or one or more servers 206 may transmit data over network 230, e.g., network 101.

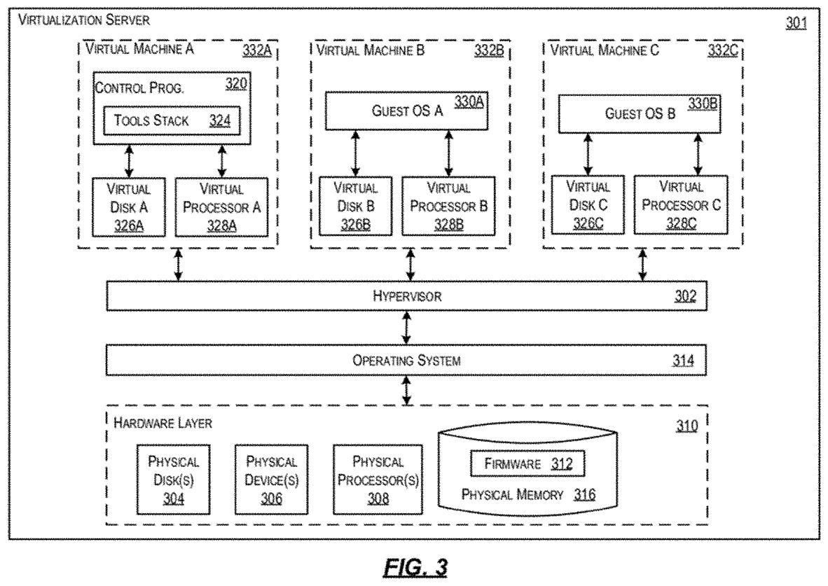

FIG. 3 shows a high-level architecture of an illustrative application virtualization system. As shown, the application virtualization system may be single-server or multi-server system, or cloud system, including at least one virtualization server 301 configured to provide virtual desktops and/or virtual applications to one or more terminals 240 (FIG. 2). As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an operating system running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer 310 that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may execute at a level above the hypervisor. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301 and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in virtualization server 301 hardware layer 310. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; the XENPROJECT hypervisor, an open source product whose development is overseen by the open source XenProject.org community; HyperV, VirtualServer or virtual PC hypervisors provided by Microsoft Corporation, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the XENSERVER provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all the same characteristics of at least one physical processor 308. In other embodiments, virtual processor 328 provides a modified view of physical processors 308 such that at least some of the characteristics of the virtual processor 328 are different than the characteristics of the corresponding physical processor 308.

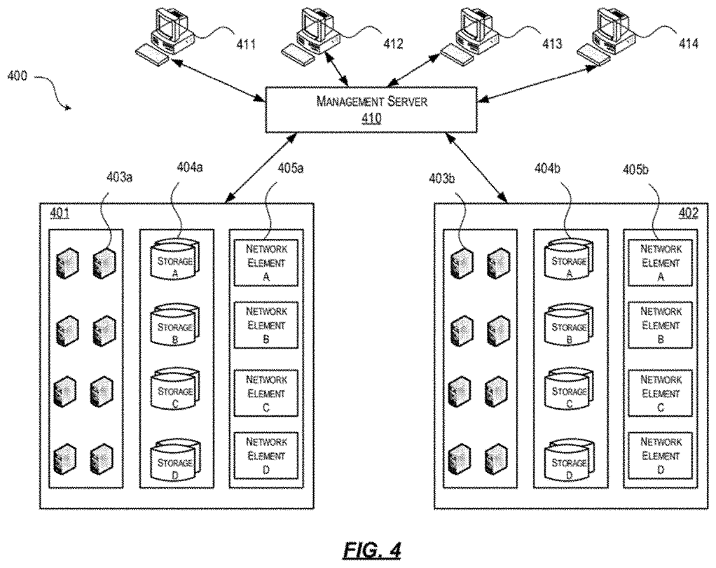

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred to herein as “host servers 403”), storage resources 404a-404b (generally referred to herein as “storage resources 404”), and network resources 405a-405b (generally referred to herein as “network resources 405”)) of the cloud system.

Management server 410 may be implemented on one or more physical servers. The management server 410 may run, for example, CLOUDPLATFORM by Citrix Systems, Inc. of Fort Lauderdale, Fla., or OPENSTACK, among others. Management server 410 may manage various computing resources, including cloud hardware and software resources, for example, host servers 403, storage resources 404, and network resources 405. The cloud hardware and software resources may include private and/or public components. For example, a cloud environment may be configured as a private cloud environment to be used by one or more customers or client computers 411-414 and/or over a private network. In other embodiments, public cloud environments or hybrid public-private cloud environments may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud environment. Client computers 411-414 may connect to management server 410 via the Internet or some other communication network and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain client computers 411-414 may be related, for example, different client computers creating virtual machines on behalf of the same end user, or different users affiliated with the same company or organization. In other examples, certain client computers 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud computing resources. For example, zone 401 may be a first cloud datacenter located in California and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud environment (e.g., client computers 411-414) might or might not be aware of the distinctions between zones. For example, an end user may request the creation of a virtual machine having a specified amount of memory, processing power, and network capabilities. The management server 410 may respond to the user's request and may allocate resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more host servers 403, such as the virtualization servers 301 (FIG. 3), which may be configured to create and host virtual machine instances. The physical network resources in a cloud zone 401 or 402 may include one or more network resources 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment 400 shown in FIG. 4 also may include a virtualization layer (e.g., as shown in FIGS. 1-3) with additional hardware and/or software resources configured to create and manage virtual machines and provide other services to customers using the physical resources in the cloud environment. The virtualization layer may include hypervisors, as described above in connection with FIG. 3, along with other components to provide network virtualizations, storage virtualizations, etc. The virtualization layer may be as a separate layer from the physical resource layer or may share some or all the same hardware and/or software resources with the physical resource layer. For example, the virtualization layer may include a hypervisor installed in each of the host servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Establishing and Searching Caches

Caching is a performance optimization technique used by, e.g., search engines. In the case of search engines, caching can occur at several levels of a computing system to improve query throughput. At a lower level of the computing system, index structures of frequently used query terms are cached in main memory to save on disk transfers. At a higher level of the computing system, results of frequent search queries are cached so that search results can be returned without executing the same or similar search queries repeatedly.

Result caching and list caching are the most common mechanisms of search engine caching. Result caching techniques include caching previously issued search queries and their corresponding search results. Thus, in response to a search engine receiving a new search query that is the same or substantially similar to a previously issued cached search query, the cached search results can be returned without requiring the search engine to run a search.

List caching techniques include caching inverted lists of frequent query terms. Conventional list caching methods rely on receiving a list of search results from a search provider and caching the set of results in a data structure using the search term they were returned against as a key. When a new search is started, the list of cached search terms is searched via the keys, and if the new search is a match for any of the keys, then all those search results are returned. Any cached search terms that contain the current search term can be returned, (e.g. a search term of “do” would match with cached search terms such as “document” and “doctor”).

Accordingly, in accordance with the concepts described herein, it has been recognized that current caching techniques cannot improve query throughput for those queries that are not the same or substantially similar to previously issued queries. One limitation of conventional caching techniques is that they tie the cached results to a given search term, meaning that search results can only be extracted from a cache if the search term is already stored in the cache, or is a substring of a term stored in the cache. For a substantially different search term, cached results cannot be returned, even if results stored in the cache would be a match for the term, as the search term will not match any of the stored terms.

Furthermore, conventional caching techniques can end up storing duplicate copies of the same individual search result if it matches multiple cached search terms, which can add to memory overhead of maintaining such a cache, as well as additional deduplication steps between the cache returning to the search controller and the search controller returning to the user.

Embodiments of the present disclosure relate to techniques for improving query throughput for those queries that are not the same or substantially similar to previously issued queries. Additionally, the embodiments described herein can return cached results in response to queries that are not the same as previous queries. For example, embodiments disassociate the results from the search term with which they were originally returned. When cached results are requested, the cached results, not the search term, are searched using a current query, returning any matching results regardless of whether the search term they were originally cached for is substantially similar to a current term.

Caching the results independent from search terms allows for a single store of results per search provider, thereby reducing memory overhead caused by storing duplicate results as described above.

For example, aspects described herein are directed towards caching search results and searching the caches in response to different search queries. A search controller may establish caches for each of a plurality of search providers. The search controller stores search results received from the plurality of search providers in their corresponding caches in a searchable format and independent from the search term(s) which caused the search results to be returned. Thus, in response to receiving a search query from the client device, the search controller can search the caches and initiate the searches by each of the search providers for search results. The search controller returns the results to the client device. The search controller may also cache some or all results received from the search providers in their respective caches. As noted above, the search controller caches the results independent from search terms to reduce memory overheads caused by storing duplicate results as described above.

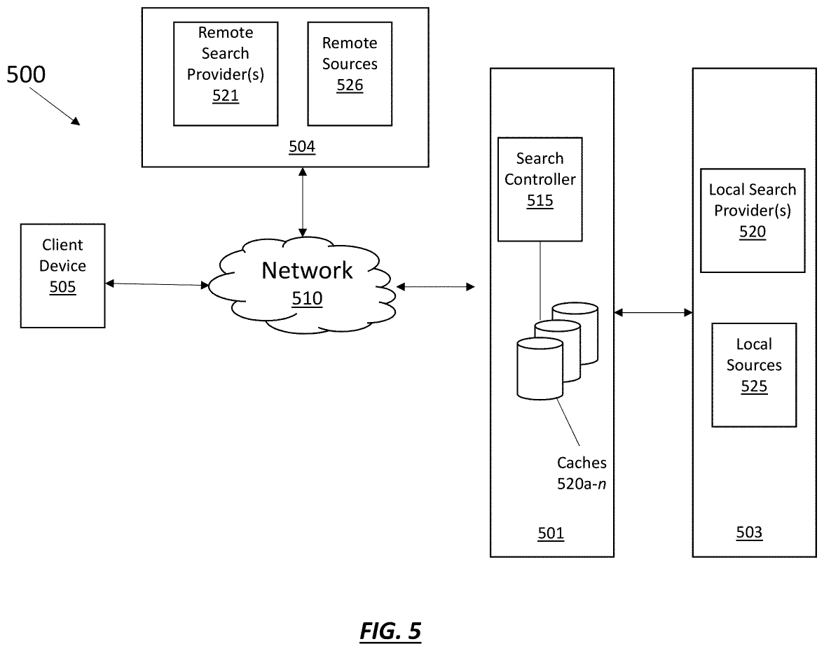

Regarding FIG. 5, a computing environment 500 includes a client device 505 communicatively coupled to servers 501, 503, 504 via network 510. In an embodiment, the client device 505 can establish a computing session with a virtual machine (VM) (e.g., such as a VM 332 of FIG. 3) executed by a virtualization server 501 (e.g., such as virtualization server 301 of FIG. 3). The client device 505 can include a user interface (UI) (not shown) that enables a user of the client device 505 to enter search queries for one or more documents, files, data, software applications (“app”), or other pieces of information available within the computing environment (collectively referred to herein as “resources”).

Servers 501, 503, 504 may comprise sources having resources stored thereon. The resource can be stored by local sources 525 or remote sources 526. The local sources 525 can be “local” with respect to the VM and hosted by the virtualization server 501 and/or a local resources server 503. The remote sources 526 can be “remote” with respect to the VM and hosted by a remote server 504. The computing environment 500 can be a cloud computing environment (e.g., such as cloud system 400 of FIG. 4) and client device 505 can be configured to operate substantially similar to terminals 240 of FIG. 2 or client computers 411-414 of FIG. 4. The network 510 can be substantially similar to networks 101, 230 of FIGS. 1-2, respectively.

Embodiments described herein utilize one or more search result caches (e.g., caches 520a-n) having stored therein search results. A search controller 515 can search the caches 520a-n and return search results in response to search queries within a response time that is less than or equal to a threshold. The threshold can be a timeout period within which the search controller 515 performs searches. In embodiments, the search controller 515 performs searches of the caches 520a-n regardless of whether a search query is the same or substantially similar to a previously issued search query. Accordingly, the search controller 515 can use one or more of the caches 520a-n to dynamically produce search results. For instance, a cache can store a result that is relevant to a search query regardless of whether that result corresponds to a previously issued search query that is distinct from a current search query.

In embodiments, the virtualization server 501 can include a search controller 515 configured to process search queries, e.g., search queries entered by a user via the UI on the client device 505. The search controller 515 is communicatively coupled to one or more search providers such as local search provider(s) 520 and remote search provider(s) 521. The search providers 520, 521 include search engines and/or algorithms that are configured to perform searches of sources 525, 526, respectively. For example, a search provider can be implemented as any service, component within an application, or part of a user interface itself that contains data that the user may wish to access. Examples of search providers include, but are not limited to, external services accessible via a network request that accept search criteria and return search results, an operating system on which a program is executing or resident, and internal data stores within the programs.

The sources 525, 526 store information, data, and/or resources that may be the subject of a search query. For example, a source can be a data structure that contains resources that can be search through, via a search provider. One search provider can have many sources, and many search providers could search the same source. Sources can also contain multiple types of resources. Files stored in the file system of a computer that the computer's operating system can search and return results to an application running on the computer is an example of a source and search provider relationship. In this example, the files are the resource, stored in the file system, which is the source of the resources. This source is then searched by the operating system, acting as a search provider. The search provider can return results from many sources, and in this example the operating system can return installed applications and thus, a list of installed applications can also be a source.

For each of the search providers 520, 521, the search controller 515 can establish a respective cache (e.g., one of the caches 520a-n). Each of the caches 520a-n stores results from searches such that the caches 520a-n can be queried for search results. In some embodiments, the search controller 515 can establish a single cache to store the results received from the search providers 520, 521. In other embodiments, a plurality of caches may be used. In general, a trade-off may be made between the number of caches relative to the number of search providers. The number of caches to use in a particular application may be selected based on a variety of factors including, but not limited to an overall storage size of one or more caches, ability to parallelize a search, and specificity of the sources associated with each of the search providers 520, 521. For example, the search controller 515 can establish distinct caches for each of the search providers 520, 521 if they are associated with unique sources. In other examples, the search controller 515 can establish a common cache or shared caches for the search providers 520, 521 if they are associated with similar sources.

In some cases, the search providers 520, 521 may return duplicate results (e.g., a word document titled “Patent-Application.doc” with the same modification date). In embodiments where distinct caches are established for the search providers 520, 521, the search controller 515 caches the documents in the respective caches 520a-n and prior to returning the results to the user, the search controller 515 can perform any de-duplication technique known in the art. In embodiments where a common cache or shared caches are established, the search controller 515 stores one copy of the duplicate result in the common cache or one of the shared caches and generates an index that associates the duplicate results with both the search providers 520, 521. As such, the search controller 515 can avoid storing duplicate results in the common cache or shared caches. In response to receiving a subsequent search query, the search controller 515 can perform a search of the common cache or shared caches using the index.

In response to receiving a search query, the search controller 515 selects one or more search providers such as local search providers 520 and remote search providers 521 to which to issue the search query. In embodiments, the search controller 515 registers the search providers 520, 521 and determines the types of sources from which the search providers 520,521 can return search results. For example, type of sources can include lists of user settings, desktop connections, browser history, website favorites, list of employees in a company.

For example, the search controller 515 can register the search providers 520, 521 in response to receiving responses from the search providers 520, 521 to a discovery signal issued by the search controller 515. Any registration technique known such as discovery registration may be used. In embodiments, the responses from the search providers 520, 521 includes information related to accessing the search providers 520, 521 (e.g., URLs of the search providers or a command function to access the search providers) and an identifier (e.g., a unique alpha-numeric number) of the search provider. Accordingly, the search controller 515 determines types of sources that may fulfill the search query and selects those search providers registered as being able to return the determined types of sources.

The search controller 515 performs searches of those selected search providers and the caches 520a-n associated with each of the selected search providers. In embodiments, the search controller 515 can perform the searches sequentially or in parallel. In other embodiments, the search controller 515 can perform searches of those search providers 520, 521 corresponding to recently and/or most commonly requested resources. The search controller 515 returns, to the client device 505, the search results obtained from the caches 520a-n and received from the search providers. With this arrangement, the caches 520a-n essentially provide an additional source, potentially returning results more quickly than sources 525, 526.

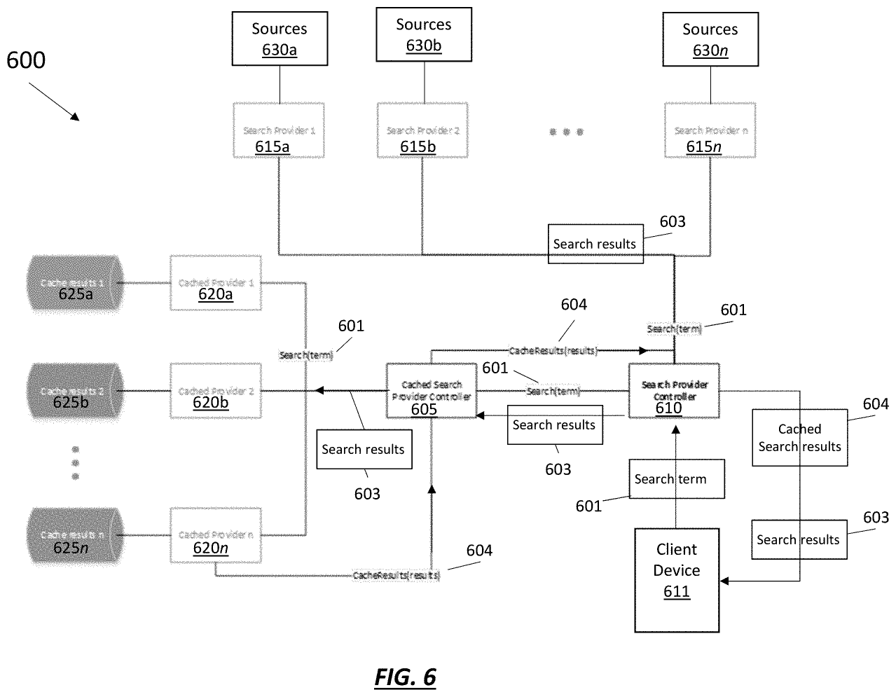

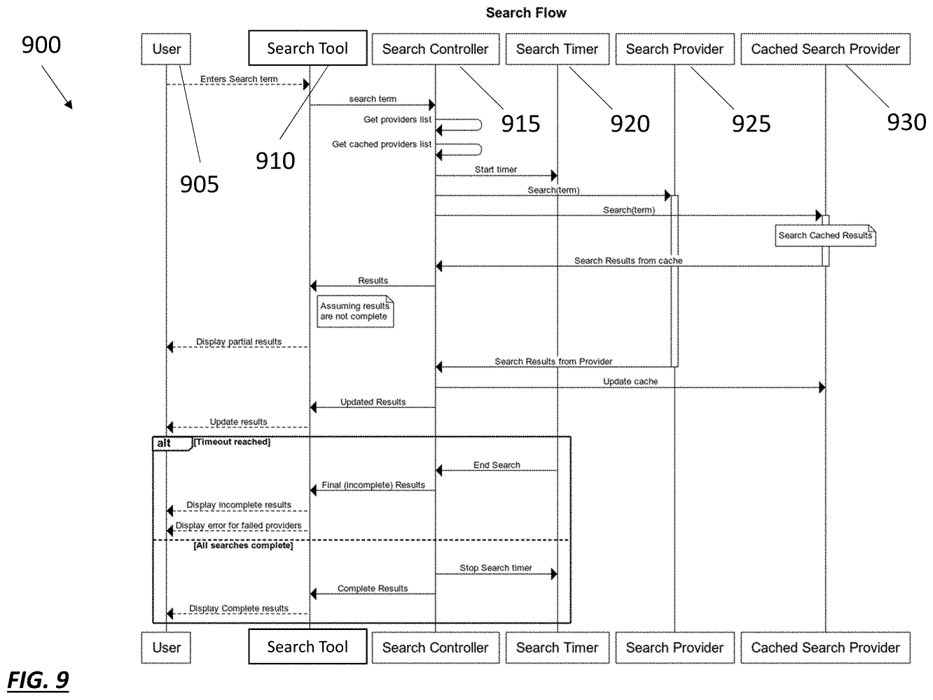

Regarding FIG. 6, a computing environment 600 includes a search provider controller 610 and a cached search provider controller 605 that are configured to process search queries (e.g., search query 601 including a search term) received from a client device 611 and return results from one or more sources 630a-n and/or from one or more caches 625a-n. In embodiments, the search provider controller 610 and the cached search provider controller 605 can be implemented as a single search controller (e.g., the search controller 515 of FIG. 5 or the search controller 915 of FIG. 9). The client device 611 can be substantially similar to the client device 505 of FIG. 5.

The search controller 610 registers one or more search providers 615a-n such that the search controller 610 can issue search queries to one or more of the registered search providers 615a-n based on the types of sources associated with each of the search providers 615a-n. For example, the search controller 610 can issue a discovery signal to a network and await responses from search providers 615a-n. Each response can include a search function location of a subject search provider, a unique identifier of the subject search provider, meta-data identifying results types offered by the subject search provider, information identifying whether the subject search provider is local or external to the search controller 610 and return format schemas amongst other information. In embodiments, each of the search providers 615a-n can include a search engine configured to search sources 630a-n communicatively coupled to the respective search provider.

For each or some of the registered search providers 615a-n, the cached search controller 605 can establish respective caches 625a-n. The cached search controller 605 can establish caches for those search providers 615a-n that meet predetermined criteria. For example, the criteria can include whether a network request is required to send a request to a search provider, a response time of a search provider, a type of results returned by a search provider.

In some embodiments, the cached search controller 605 establishes caches for each registered search provider. For example, if each registered search provider is a remote search provider similar to the search provider 521, the cached search controller 605 established caches for each search provider.

In other embodiments, the cached search controller 605 establishes caches for a subset of the registered caches. For example, the cached search controller 605 can establish caches 625a-n for those search providers 615a-n that return search results with a response time that exceeds a threshold. To determine response times, the cached search controller 605 can be pre-configured with a set of search queries that each have differing complexities of search terms. The cached search controller 605 can issue one or more of the pre-configured search queries to the search providers 615a-n and measure search result response times. Based on the response times, the cached search controller 605 determines whether to establish a cache for any given search provider. Thus, for each search provider that has a slow response time (e.g., a response time greater than a threshold) the cached search controller 605 establishes a respective cache configured to return search results with a response time less than the threshold in response to a search query. Accordingly, the cached search controller 605 can effectively speed up response times of those search providers having response times greater than the threshold. For example, the caches 625a-n are stored locally with respect to the search controller 610 and the cached search controller 605 to speed up response times.

In other embodiments, the cached search controller 605 establishes caches for remote search providers such as remote search provider(s) 521 of FIG. 5. Additionally, the cached search controller 605 determines a size for each of the caches 625a-n. In embodiments, the cached search controller 605 can establish the caches 625a-n with an initial starting size and dynamically increase the size as the caches 625a-n fill up. For example, the cached controller 605 can increase the size of a cache upon reaching a predetermined percent capacity (e.g., 75-80%). Additionally, the cached search controller 605 can set a maximum cache size limit above which a cache size cannot increase. Accordingly, if a cache reaches the cache size limit, the cached search controller 605 can delete entries according to any known data prioritization technique. For example, entries may be deleted based on age, frequency with which the entry is returned in response to searches, and any other factor.

For each of the established caches 625a-n, the cached search controller 605 encodes a data structure that is configured to store search results in a searchable structure. For example, the data structure can store each search result as a key-value pair, amongst other searchable formats. In embodiments, a key includes one or more properties used by a search algorithm to select whether an item should be included in a set of search results. A value includes a set of properties that define a single item. The single item can be a single search result (e.g., resource) that is returned by a search provider.

Further, the cached search controller 605 establishes respective cached search providers 620a-n for each of the caches 625a-n. For example, the cached search controller 605 can provide each of the cached search providers 620a-n with a search engine and/or search algorithm configured to process a search query and search respective caches 625a-n for search results. The search engine for each of the cached search providers 620a-n can correspond to the search engines of respective search providers 615a-n. In other embodiments, the search engine can be a default search engine optimized to perform searches of a cache. For example, the default search engine can include a static algorithm that provides relevant results for a general case. In other examples, the default search engine can include a dynamic self-learning algorithm that can adapt and adjust itself by comparing results returned from the cache and results returned from a respective search provider.

The cached search controller 605 registers each of the cached search providers 620a-n such that the cached search controller 605 can issue search queries to one or more of the registered cached search providers 620a-n based on the types of sources associated with each of the cached search providers 620a-n. For example, the cached search providers 620a-n can return the same type of sources as their respective counterpart search providers 615a-n.

In operation, a user of the client device 611 enters a search query comprising one or more a search terms via a UI (not shown) of the client device 611. The search terms can include, for example, one or a string of characters (e.g. one or more alphanumeric characters including one or more words or one or more phrases, or one or more non-alphanumeric symbols) requesting one or more resources. The client device 611 transmits the search query 601 to the search controller 610, e.g., via a network such as network 510 of FIG. 5. In response to receiving the search query 601, the search controller 610, selects a set of the search providers 615a-n to which to issue (e.g. transmit or otherwise provide to) the search query 601. For example, the search controller 610 can determine the types of sources that may fulfill the search query and select those search providers registered as being able to return the determined types of sources. For example, the search query can include meta-data identifying the types of sources. In embodiments, the UI can present selectable search type options (e.g., via click boxes or radio buttons) which the user can select when entering a search query. In other embodiments, the search controller 610 can parse the string of characters of the search term to determine the type of source. For example, the search controller 610 can assume that a user who has entered search term include string of characters such as “.txt” is searching for a file matching that extension.

The search controller 610 issues the search query 601 to the selected search providers (e.g., the set of the search providers 615a-n). The search controller 610 sends a signal that includes the search query 601 to the cached search controller 605 and/or the selection of the search providers 615a-n. The cached search controller 605 issues the search query 601 to those cached providers 620a-b that correspond to the set of search providers 615a-n.

In response to receiving the search query 601, each of the search providers 615a-n and the cached search providers 620a-n format the query into a format suitable for searching their respective sources 630a-n and caches 625a-n. The format can be based on a type of search provider and/or source associated with the search provider. In other examples, the search query 601 is formatted according to the search engine implemented by each of the search providers 615a-n and the cached search providers 620a-n.

The search providers 615a-n and the cached search providers 620a-n return their respective search results 603 and cached search results 604 to the search controller 610. The search controller 610 provides the search results 604 to the cached search controller 605 for storage in the appropriate caches 625a-n. For example, results provided by search provider 615a are stored in cache 625a. In embodiments, the search controller 610 and/or the cached search controller 605 can compare the search results 603 and the cached search results 604 to identify any differences between the results and the cached search controller 605 can update the caches 625a-n based on the differences. For example, if a file returned from the cache 625b is a first version, and the corresponding file returned from search provider 615b is a second updated version, the cached search controller 605 updates the cache 625b with the second updated version.

In response to receiving the search results 603 and the cached search results 604, the search controller 610 sends a set of the results to the client device 611. The set of results can include some of the cached search results 604 and some of the search results 603. For example, the search controller 610 only returns those search results 603 that are either updated as compared to the cached search results 604 and/or those search results 603 not included within the cached search results 604. Upon receiving the results, the client device 611 presents the results on the UI. The UI can be adapted to display representations of a resource associated with a search result.

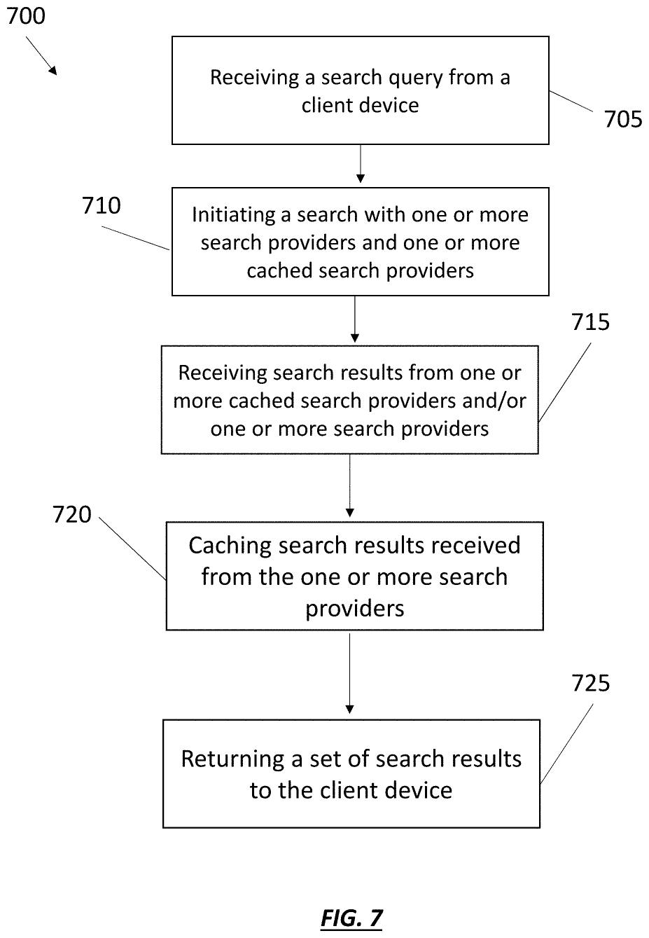

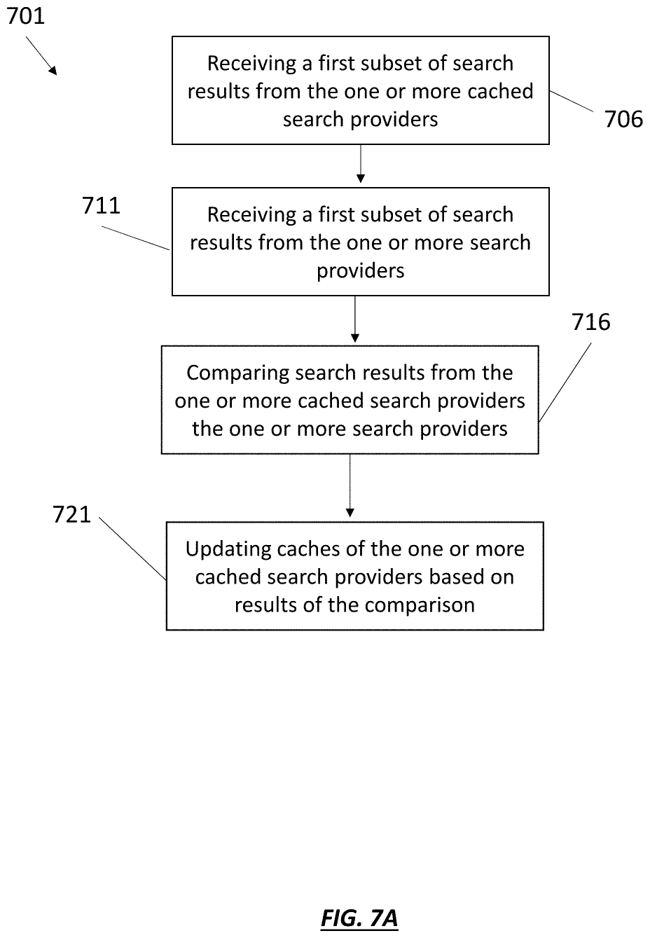

Regarding FIG. 7, a method 700, at 705, includes receiving, by a search controller (e.g., any one of the controllers 515, 610, 915 of FIGS. 5-6 & 9, respectively) a search query (e.g., query 601 of FIG. 1) from a client device such a device 505 of FIG. 5. The method 700, at 710, further includes initiating, by the search controller, a search with one or more search providers and one or more cached search providers (e.g., the search providers 615a-n and the cached search providers 625a-n of FIG. 6). Initiating the search with the search providers and cached search providers, can include selecting, by the search controller, the search providers and the cached search providers to which to perform the search as described in greater detail with respect to FIGS. 5-6. In response to initiating the search, the method 700, at 715, includes receiving, by the search controller, search results (e.g., the search results 603 and/or the cached search results 604 of FIG. 6) from the search providers and/or the cached search providers. In embodiments, a search result can include a NULL value if a query does not yield a hit from either the search providers and/or the cached search providers. The method 700, at 720, further includes caching, by the search controller, the search results from the search providers in one or more corresponding caches as previously described in greater detail with respect to FIGS. 5-6. The method 700, at 725, includes returning a set of the search results to the client device as described in greater detail with respect to FIGS. 6 & 9.

Regarding FIG. 7A, a method 701, at 706, includes receiving, by a search controller (e.g., any one of the controllers 515, 605, 610, 915 of FIGS. 5-6 & 9, respectively) a first subset of search results (e.g., the cached search results 604 of FIG. 6) from one or more cached search providers (e.g., the cached search providers 620a-n of FIG. 6). The method 701, at 711, also includes receiving, by the search controller a second subset of search results (e.g., the search results 603 of FIG. 6) from one or more search providers such as the search providers 615a-n of FIG. 6. At 716, the method 701 includes comparing, by the search controller the first subset and second subset. The method, at 721, further includes updating the caches (e.g., the caches 625a-n of FIG. 6) based on results of the comparison as described above with respect to FIG. 6.

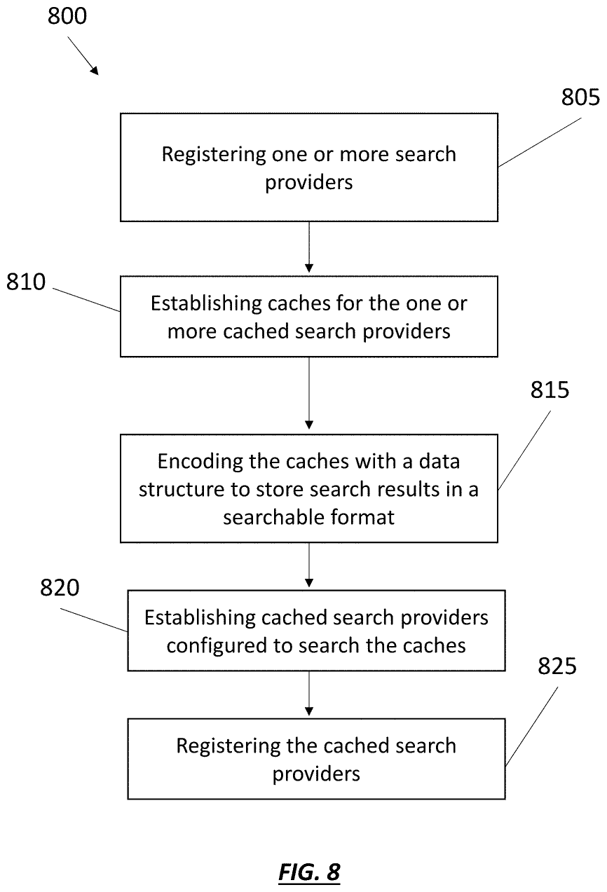

Regarding FIG. 8, a method 800, at 805, includes registering, by a search controller (e.g., any one of the controllers 515, 605, 610, 915 of FIGS. 5-6 & 9, respectively) one or more search providers such as the search providers 615a-n of FIG. 6. The search controller can register the search providers according to the techniques previously described in greater detail with respect to FIGS. 5-6. The method 800, at 810, also includes establishing, by the search controller, caches (e.g., caches 625a-n) for one or more of the search providers. The search controller can establish the caches according to the techniques described in connection with FIG. 6. Further, the method 800, at 815, includes encoding, by the search controller, the caches with a data structure configured to store search results in a searchable format as described in detail with respect to FIG. 6. Additionally, the method 800, at 820, includes establishing, by the search controller, cached search providers (e.g., cached search providers 620a-n of FIG. 6) for each of the caches. The search controller can provide each of the cached search providers with a search algorithm configured to search the data structure as described with respect to FIG. 6. Further, the method 800, at 825, includes registering each of the cached search providers as described in detail with respect to FIG. 6.

Regarding FIG. 9, an example process flow 900 begins with a user 905 entering a search term (e.g., such as search query 601 of FIG. 6) on a search tool 910 running on a client device (e.g., the UI on the client device 611 of FIG. 6). In response to receiving the search term, the search tool 910 sends the search term to a search controller 915 over a network such as the network 510 of FIG. 5. The search controller 915 can be substantially similar to the search controllers 515, 605, 610 of FIGS. 5-6, respectively.

Upon receiving the search term, the search controller 915 determines to which search providers 925 and which cached search providers 930 of a plurality of search providers and a plurality of cached search providers (e.g., the search providers 615a-n and cached search providers 620a-n of FIG. 6) to send the search term. The search controller 915 can make the determination according to the techniques described with respect to FIGS. 5-6.

Once the determination is made, the search controller 915 can send the search term to the search providers 925 and the cached search providers 930. The search controller 915 can include a search timer 920 and start the search timer 920 when the search term is sent to the search providers 925 and the cached search providers 930. The search timer 920 can be pre-programmed with a search limit (e.g., threshold as defined above with respect to FIG. 6). In other embodiments, the search controller 915 can dynamically set the search timer 920 based on a complexity of the search term. For example, the search controller 915 can determine a complexity of the search term based on a number and/or type of characters included in the search term. For example, the greater the complexity of the search term, the search controller 915 can set the search timer 920 with a greater search limit. Thus, for less complex search terms, the search timer 920 is set with a lower search limit.

In an embodiment, the search controller 915 first receives cached search results (e.g., the cached search results 604 of FIG. 6) from the cached search providers 930. For example, the cached search providers 930 are communicatively coupled to caches (e.g., such as caches 625a-n of FIG. 6) that are local to the search controller 915. Additionally, the caches can store search results in a searchable data structure which can make searches more efficient. In an example, the caches store the search results in a key-value pair format. The search controller 915 provides the cached search results to the search tool 910 which displays the cached search results to the user 905 (e.g., a partial result as it does not include results from the search provider 925).

The search controller 915 also receives search results (e.g., the search results 603 of FIG. 6) from one or more search providers 925. The search controller 915 analyzes the search results and compares them to the cached search results. The search controller 915 updates the caches according to one or more of the techniques described with respect to FIG. 6. Additionally, the search controller 915 provides updated results to the search tool 910 (e.g., those search results updated as compared to the cached search results and/or those search results not included within the cached search results as described with respect to FIG. 6). In response to receiving the updated results, the search tool 910 displays the updated results to the user 905.

In some embodiments, the process 900 can wait for all results (e.g., search results and cached search results) to be returned before displaying results to the user 905. In other embodiments, the process 900 can wait for the search timer 920 to reach the search limit before displaying all the results to the user 905.

In an embodiment, the search timer 920 can reach the search limit before all cached search results and/or search results are returned to the search controller 915. In such a scenario, the search timer 920 sends an end search signal to the search controller 915, which in turn sends the incomplete results (cached search results and/or search results) to the search tool 910 along with an indication of a search error. The search tool 910 displays the incomplete results along with a search error to the user. The search error can be a notice that advises the user to refine the entered search term as there may be too many hits on the entered search term.

In another embodiment, the search controller 915 can receive an indication from the search providers 925 and the cached search providers 930 that all possible search results and/or cached search results have been returned. Accordingly, the search controller 915 can send a stop timer signal to the search timer 920 and transmits a complete result set (e.g., one that includes both search results and cached search results as applicable) to the search tool 910. The search tool 910 displays the complete results to the user 905.

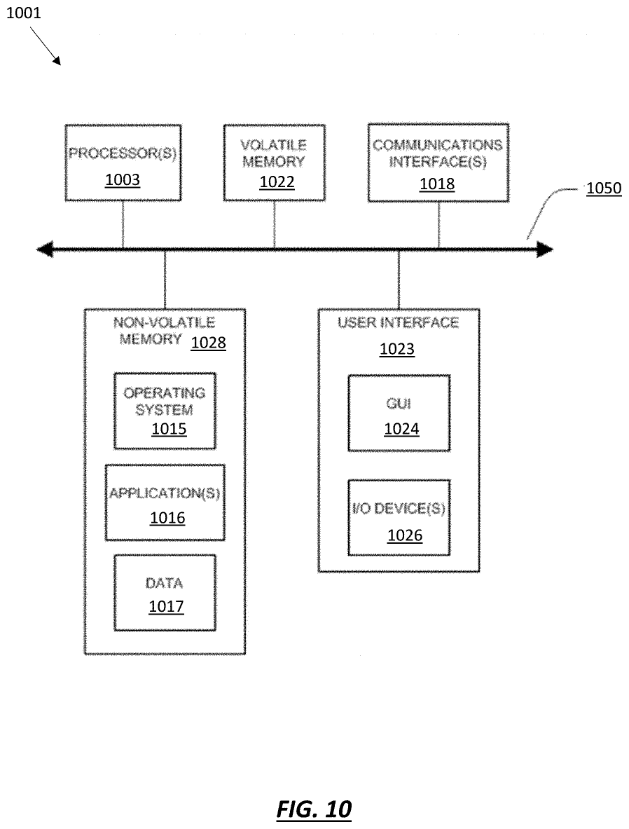

As shown in FIG. 10, computer 1001 may include one or more processors 1003, volatile memory 1022 (e.g., RAM), non-volatile memory 1028 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 1023, one or more communications interfaces 1018, and communication bus 1050. User interface 1023 may include graphical user interface (GUI) 1024 (e.g., a touchscreen, a display, etc.) and one or more input/output (I/O) devices 1026 (e.g., a mouse, a keyboard, etc.). Non-volatile memory 1028 stores operating system 1015, one or more applications 1016, and data 1017 such that, for example, computer instructions of operating system 1015 and/or applications 1016 are executed by processor(s) 1003 out of volatile memory 1022. Data may be entered using an input device of GUI 1024 or received from I/O device(s) 1026. Various elements of computer 1001 may communicate via communication bus 1050. Computer 1001 as shown in FIG. 10 is shown merely as an example of components 107, 107, and 109 of FIG. 1, terminals 240 of FIG. 2, client computers 411-414 of FIG. 4, client device 505 of FIG. 5, and client device 611 of FIG. 6. A skilled artisan understands that components 107, 107, and 109, terminals 240, client computers 411-414, client device 505, and client device 611 may be implemented by any computing or processing environment and with any type of machine or set of machines that may have suitable hardware and/or software capable of operating as described herein.

Processor(s) 1003 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located) processors.

Communications interfaces 1018 may include one or more interfaces to enable computer 1001 to access a computer network such as a LAN, a WAN, or the Internet through a variety of wired and/or wireless or cellular connections.

In described embodiments, a first computing device 1001 may execute an application on behalf of a user of a client computing device (e.g., a client 102), may execute a virtual machine, which provides an execution session within which applications execute on behalf of a user or a client computing device (e.g., any of the client computers 411-414 of FIG. 4), such as a hosted desktop session, may execute a terminal services session to provide a hosted desktop environment, or may provide access to a computing environment including one or more of: one or more applications, one or more desktop applications, and one or more desktop sessions in which one or more applications may execute.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the embodiments described herein by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the concepts described may be embodied in other specific forms without departing from the spirit or essential characteristics thereof. The foregoing embodiments are therefore to be considered in all respects illustrative rather than limiting of the concepts described herein. Scope of the concepts is thus indicated by the appended claims, rather than by the foregoing description, and all changes that come within the meaning and range of equivalency of the claims are therefore intended to be embraced therein.

What is claimed is:

1. A method comprising:
searching, by a search controller, search results stored in one or more caches in response to a search query initiated from a client device, wherein the search results stored in the one or more caches are cached from search results received from respective one or more search providers in response to one or more other search queries;
obtaining, by the search controller, a first subset of search results from the one or more caches, wherein the first subset of the search results is obtained by searching for results in at least one of the one or more caches using one or more search terms which form the search query initiated from the client device;
receiving, by the search controller, a second subset of search results from one or more search providers; and
returning, by the search controller, a set of search results second subset to the client device that includes at least one search result from the first subset of search results to reduce a response time to retrieve the search results.

2. The method of claim 1, wherein the second subset of search results include search results that update one or more results of the first subset of search results and/or add new search results to the first subset of search results.

3. The method of claim 1, further comprising registering the one or more search providers by the search controller, wherein registering the one or more search providers includes:
identifying the one or more search providers; and
determining one or more types of sources from which each of the identified search providers can return search results in response to search queries.

4. The method of claim 2 further comprising:
establishing, by the search controller, one or more cached search providers, wherein each of the one or more cached search providers corresponds to a respective one of the one or more search providers; and
coupling, by the search controller, each of the one or more cached search providers to the respective one of the one or more caches.

5. The method of claim 3 further comprising in response to receiving the search query:
determining, by the search controller, the one or more types of sources to fulfill; and
selecting, by the search controller, the one or more search providers from which to obtain search results based on the determined one or more types of sources to fulfill.

6. The method of claim 4 further comprising selecting, by the search controller, the one or more cached search providers from which to obtain search results based on the determined one or more types of sources to fulfill.

7. The method of claim 3 further comprising in response to receiving search results from the one or more search providers, storing, by the search controller, each of the search results in the one or more caches.

8. The method of claim 6 wherein storing each of the search results in the one or more caches includes formatting each of the search results into a searchable structure, and wherein the searchable structure is a key-value pair.

9. The method of claim 8 wherein:
a key of the key-value pair includes one or more properties used by a search algorithm to select whether an item should be included in a set of search results, and
a value of the key-value pair includes a set of properties that define a single item in the set of search results.

10. The method of claim 3 wherein establishing the one or more cached search providers includes determining a response time at which the one or more search providers can return search results and establishing the respective one or more cached search providers if the response time exceeds a threshold.

11. A server comprising:
one or more caches;
a search controller coupled to the one or more caches, the search controller configured to:
perform a search of search results stored in the one or more caches in response to a search query initiated from a client device, wherein the search results stored in the one or more caches are cached from search results received from respective one or more search providers in response to one or more other search queries;
obtain a first subset of search results from the one or more caches, wherein the first subset of the search results is obtained by searching for results in at least one of the one or more caches using one or more search terms which form the search query initiated from the client device;
receive a second subset of search results from one or more search providers; and
return a set of search results second subset to the client device that includes at least one search result from the first subset of search results to reduce a response time to retrieve the search results.

12. The server of claim 11, wherein the second subset of search results include search results that update one or more results of the first subset of search results and/or add new search results to the first subset of search results.

13. The server of claim 11 wherein the search controller is further configured to register the one or more search providers by:
identifying the one or more search providers; and
determining one or more types of sources from which each of the identified search providers can return search results in response to search queries.

14. The server of claim 12 wherein the search controller is further configured to:
establish one or more cached search providers, wherein each of the one or more cached search providers corresponds to a respective one of the one or more search providers; and
couple each of the one or more cached search providers to the respective one of the one or more caches.

15. The server of claim 13 wherein in response to receiving the search query, the search controller is further configured to:
determine the one or more types of sources to fulfill; and
select the one or more search providers from which to obtain search results based on the determined one or more types of sources to fulfill.

16. The server of claim 14 wherein the search controller is further configured to select the one or more cached search providers from which to obtain search results based on the determined one or more types of sources to fulfill.

17. The server of claim 13 wherein in response to receiving search results from the one or more search providers, the search controller is further configured to store each of the search results in the one or more caches.

18. The server of claim 16 wherein the search controller is further configured to format each of the search results into a searchable structure, wherein the search structure is a key-value pair, and wherein:
a key of the key-value pair includes one or more properties used by a search algorithm to select whether an item should be included in a set of search results, and
a value of the key-value includes a set of properties that define a single item of the set of search results.

19. The server of claim 13 wherein the search controller is configured to establish the one or more caches search providers by determining a response time at which the one or more search providers can return search results and establishing the respective one or more cached search providers if the response time exceeds a threshold.

20. A non-transitory computer-readable medium comprising computer-executable instructions, which when executed by one or more processors, cause the one or more processors to:
perform a search of search results stored in the one or more caches in response to a search query initiated from a client device, wherein the search results stored in the one or more caches are cached from search results received from respective one or more search providers in response to one or more other search queries;
obtain a first subset of search results from the one or more caches, wherein the first subset of the search results is obtained by searching for results in at least one of the one or more caches using one or more search terms which form the search query initiated from the client device;
receive a second subset of search results from one or more search providers; and
return a set of search results second subset to the client device that includes at least one search result from the first subset of search results to reduce a response time to retrieve the search results.
